(19) United States
(12) Patent Application Publication
(10) Pub. No.: US 2025/0094213 A1
(43) Pub. Date: Mar. 20, 2025

(54) Fractionalized Task Distribution and Throttling Framework for High-Volume Transactions

(71) Applicant: ServiceNow, Inc., Santa Clara, CA (US)

(72) Inventor: Walter James Brame, I, San Diego, CA (US)

(21) Appl. No.: 18/368,854

(22) Filed: Sep. 15, 2023

(51) Int. Cl. G06F 9/48

(52) U.S. Cl. CPC G06F 9/4881

(57) ABSTRACT

An example embodiment may involve: receiving a request relating to a plurality of parallelizable jobs; obtaining a schedule of worker thread availability with respect to a fractionalized task distributor, wherein the fractionalized task distributor is operable according to a predefined number of worker threads; assigning, to the fractionalized task distributor, a plurality of worker threads for execution of the plurality of parallelizable jobs, wherein the plurality of worker threads is based on the predefined number of worker threads, and wherein assigning the plurality of worker threads is according to the schedule and one or more tasks not included in the plurality of parallelizable jobs; and directing the fractionalized task distributor to execute the plurality of parallelizable jobs via the plurality of worker threads.

### BACKGROUND

Large-scale, multi-service computing platforms can simultaneously execute tens or hundreds of applications for hundreds or thousands of users. In operation, these applications execute independently of one another, obtaining processing, memory, and communication resources as needed. Some applications are tasked with moving high volumes of data out of and/or into the platform (e.g., backup and restore procedures). This may take the form of transmitting and/or receiving many gigabytes of data or hundreds of millions of database entries, for example. The execution of such an application can be resource-intensive and have a deleterious impact on the other applications, such as causing user interfaces to respond slowly. Further, these high-volume data transactions are often designed to operate linearly, thus resulting in the transactions taking much longer than is expected or acceptable.

### SUMMARY

Various implementations disclosed herein include efficient fractionalized task distribution for transfer of large data objects (e.g., files or sets of database entries) into and out of a computing platform. These implementations provide a fractionalized task distribution and throttling framework that allows for multiple fractionalized task distributors that intelligently share available computing resources (e.g., processing, memory, and network capacity). Notably, tasks may be pre-configured to be processed by the framework such that large tasks are broken apart into a number of smaller tasks and each smaller task represents a job that is to be completed by a worker thread. Thus, a limited amount of memory is used before the job's data is committed to long-term storage (e.g., a database or file system). Further, all of the jobs across all tasks are held at or under a maximum number of total workers that may be used at a given time. The extent of these total workers can be pre-configured to dynamically increase or decrease over time.

In this manner, fractionalized task distribution can be accomplished in a robust fashion. Individual transfers of data objects can be sped up through parallelization when computing resource availability supports doing so. Further, multiple fractionalized task distributors can share a predefined amount of these computing resources so that the computing platform remains responsive even when under heavy load. Also, the amount of computing resources reserved for sharing amongst fractionalized task distributors can vary over time, allowing the computing platform to adapt in the presence of diurnal load patterns or other scheduled tasks.

Accordingly, a first example embodiment may involve: receiving a request relating to a plurality of parallelizable jobs; obtaining a schedule of worker thread availability with respect to a fractionalized task distributor, wherein the fractionalized task distributor is operable according to a predefined number of worker threads; assigning, to the fractionalized task distributor, a plurality of worker threads for execution of the plurality of parallelizable jobs, wherein the plurality of worker threads is based on the predefined number of worker threads, and wherein assigning the plurality of worker threads is according to the schedule and one or more tasks not included in the plurality of parallelizable jobs; and directing the fractionalized task distributor to execute the plurality of parallelizable jobs via the plurality of worker threads.

A second example embodiment may involve a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a fractionalized task distributor, in accordance with example embodiments.

FIG. 7 depicts a fractionalized task distribution and throttling framework, in accordance with example embodiments.

FIG. 8 depicts fractionalized task distribution and throttling based on a capacity schedule, in accordance with example embodiments.

FIG. 9 depicts file input to a fractionalized task distributor, in accordance with example embodiments.

FIG. 10 depicts file output from a fractionalized task distributor, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

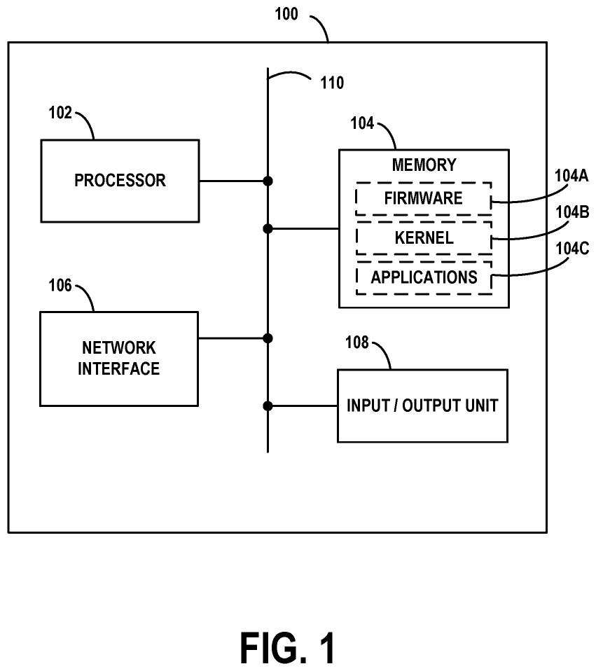

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

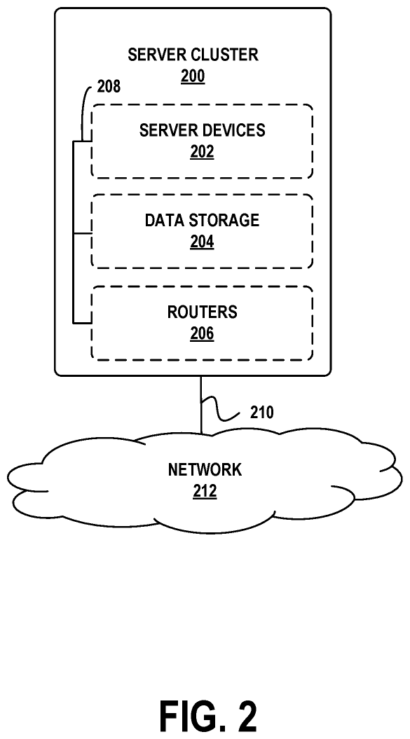

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

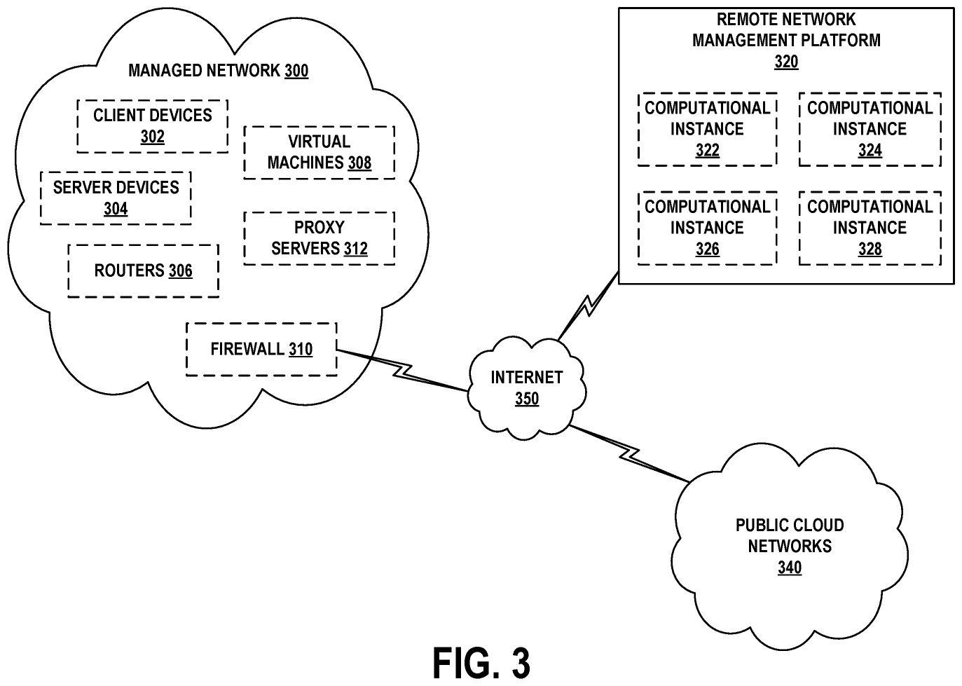

FIG. 3 depicts a remote network management architecture, in accordance with example embodiments. This architecture includes three main components-managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

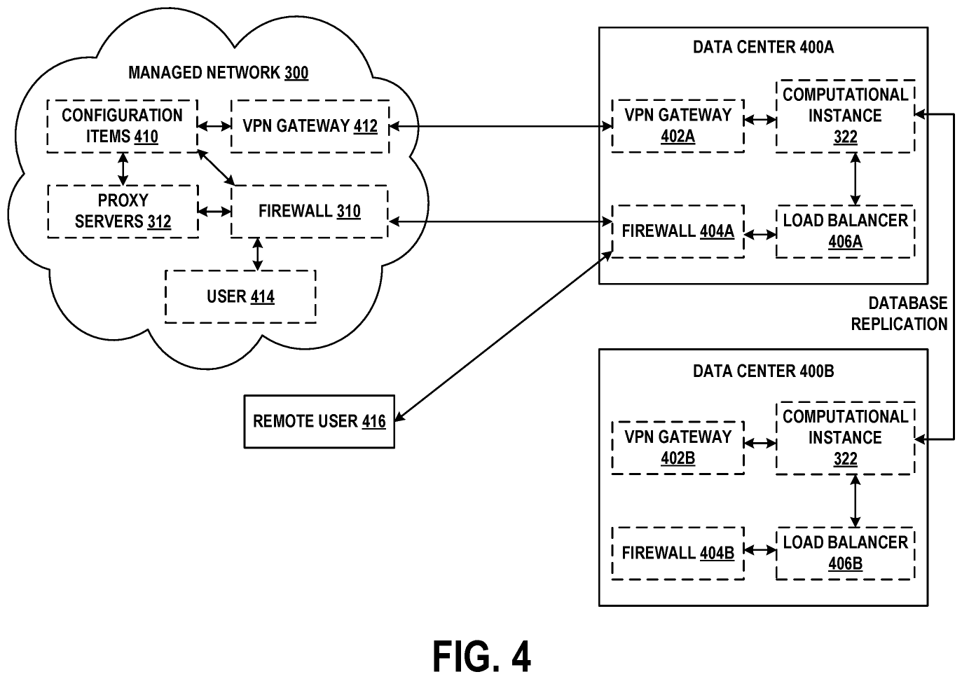

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

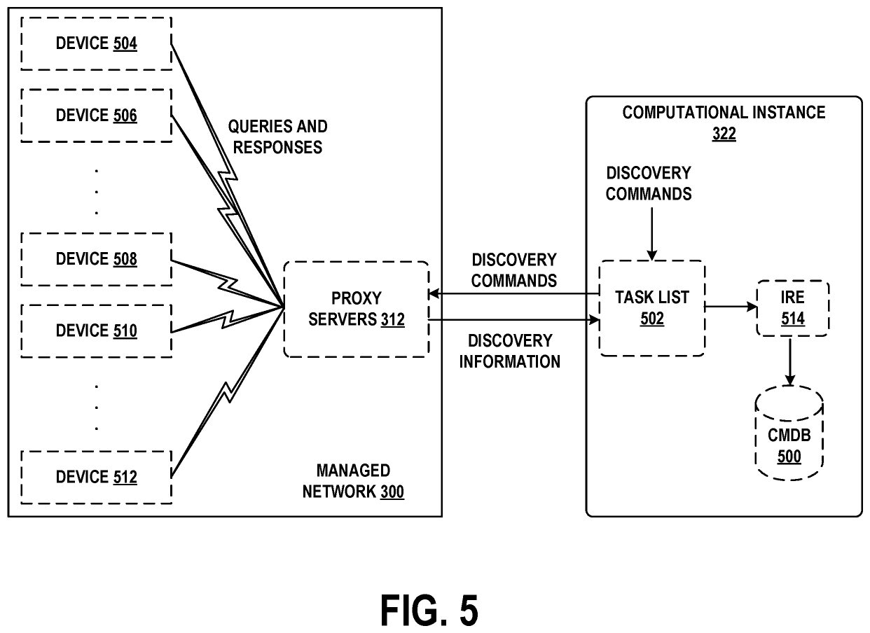

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Fractionalized Task Distribution and Throttling Framework

A large-scale computing platform, such as remote network management platform 320, may include multiple application and database nodes disposed upon some number of physical server devices or virtual machines. Any particular application or database node may be logically shared by one or more computational instances. Within each instance, there may be hundreds or thousands of processes and/or threads that provide computational services to hundreds or thousands of users. In many real-world deployments, an instance may contain database tables with hundreds of thousands or millions of entries. Thus, remote network management platform 320 may be an environment with numerous users simultaneously sharing access to the computing and database resources by way of various types of concurrent multitasking.

As these platforms have evolved, they have come to store more and more data. It is not uncommon for remote network management platform 320 to contain data objects (e.g., files and/or databases) that are multiple gigabits in size. From time to time, these data objects may be processed in various ways, such as backed up, restored from a previous backup, transmitted to a remote system, received from a remote system, scanned for viruses, and so on. The current state-of-the-art is not well-suited to handling data objects of this size, much less in a multiuser environment.

Data objects may be transmitted serially (e.g., a few hundred bytes of a file or a few database rows at a time), but such transfers may take many hours if not days when the data objects are the size of gigabytes. Further, multiple data objects being processed in parallel or one or more data objects being processed at the same time as users are navigating graphical user interfaces can result in degraded performance platform-wide. For example, the data object processing and/or user interactions may combine to use all available processor and/or main memory (RAM) resources. The result can be slow data object processing (e.g., taking hours rather than minutes), poor graphical user interface response times (e.g., more than 2-3 seconds between a graphical user interface being requested and displayed), application timeouts, general platform instability, and/or system crashes.

Thus, it is advantageous to be able to provide a framework for fractionalized task distribution and throttling across a platform that can both speed individual transactions and avoid overwhelming the platform with excessive demands for computing resources. The embodiments herein achieve these goals through a combination of features that can be used to parallelize certain serial tasks in a manner such that the volume of processing is readily controllable.

In the framework herein, some threads may be referred to as “workers” or “worker threads” and the tasks that the workers carry out may be referred to as “jobs.” Thus, at any point in time, there may be dozens of workers performing jobs, with some jobs waiting in a queue to be performed in the future. These jobs might be interactive (e.g., a user navigating a graphical user interface), transactional (e.g., a worker looking up and retrieving information from a database), communication-oriented (e.g., a worker transmitting to or receiving data from a remote system), or background (e.g., a worker traversing a filesystem and deleting files that are older than a threshold age). Transactional, communication-oriented, and background jobs may be scheduled, in that they are pre-configured to be performed at a particular time.

For sake of simplicity, a “worker” or “worker thread” may be considered to be thread of software execution that can operate in parallel to other such units. A thread represents a single flow of control within a program, and multiple threads can coexist within a single process. Each thread has its own program counter, stack, and set of registers, allowing it to execute instructions independently. Threads within the same process may share the same memory space. On platforms that do not explicitly support threads, a “worker” or “worker thread” as discussed herein may be a process.

Moreover, the terms “fractionalized task distribution and throttling” and “fractionalized task distribution” shall generally have the same meaning. Accordingly, a “fractionalized task distributor” may also be involved in throttling activities.

### A. Fractionalized Task Distributor

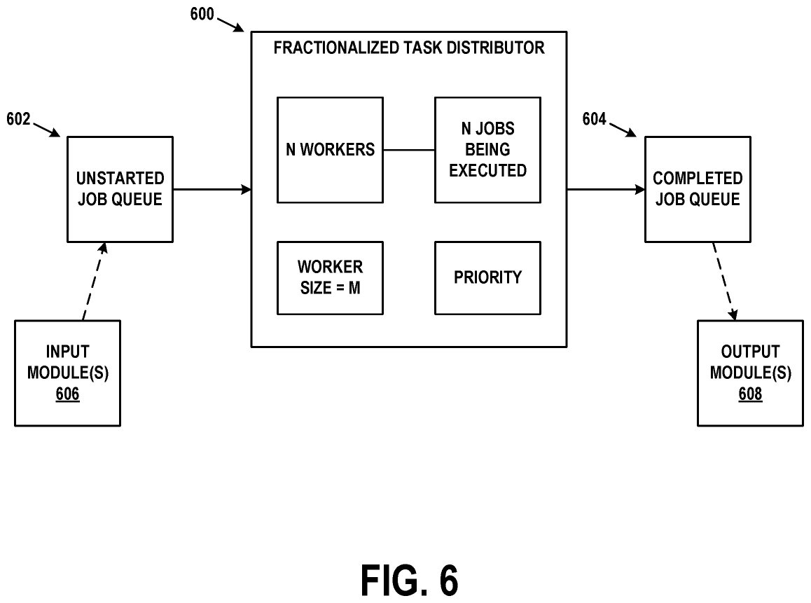

FIG. 6 depicts an example fractionalized task distributor 600. For purposes of this discussion, fractionalized task distributor 600 may be a platform-level or application-level software module with unstarted job queue 602, completed job queue 604, and to which workers can be assigned. As shown, fractionalized task distributor 600 includes a worker size of m workers each capable of executing one job at a time. Here, m can take on a wide range of values (e.g., 1, 2, 5, 10, 100, etc.).

For fractionalized task distributor 600, m may be the desired worker size, which is the maximum number of workers that it can employ simultaneously. However, fractionalized task distributor 600 might only be allocated n≤m workers. The platform may attempt to make n as close to m as possible within constraints, but n may vary over time based on platform capacity and/or demand from other fractionalized task distributors or tasks. In some cases, worker size may be specified in a shorthand or non-numeric fashion. For example, there may be four different worker sizes, e.g., small (1 worker), medium (10 workers), large (20 workers), and extra-large (40 workers). But there may be more or fewer worker sizes, and these sizes may take on different values. Setting the worker size to a reasonable number makes it impossible for processing by a fractionalized task distributor alone to monopolize the platform's resources and thus safely protects overall system performance.

Fractionalized task distributor 600 may also be configured with a priority. The priority may determine the relative precedence of this fractionalized task distributor in comparison to other fractionalized task distributors when multiple fractionalized task distributors are contending for workers or other resources. The priority may be based on the type of the jobs, the time that fractionalized task distributor 600 was started, and so on.

It is expected that the jobs are executed independently of one another, although the embodiments herein do support inter-job dependencies as well (e.g., a child job that cannot be executed into its parent job completes). Further, it is expected that each job is able to obtain the computing resources (e.g., memory) that it needs to execute, though fractionalized task distributor 600 may place some constraints on the magnitude of the resources that some jobs can utilize. In some cases, the value of m and/or n may increase or decrease based on the time of day, day of week, overall system demand, a predetermined schedule, or other factors.

A job may take the form of a script or unit of program code that is executable by any of the workers of fractionalized task distributor 600. Such a script or code may be opaque to fractionalized task distributor 600, in that fractionalized task distributor 600 receives the script or program code and executes it.

When one of the jobs completes, it may be placed on completed job queue 604 for further processing. Also, the next job in unstarted job queue 602 may be moved to fractionalized task distributor 600 for execution. If there are no jobs in unstarted job queue 602, fractionalized task distributor 600 may execute less than n jobs concurrently, and may return unused workers to a worker pool. Regardless, fractionalized task distributor 600 may proceed to execute unstarted jobs until they are all completed, moving them from unstarted job queue 602 to completed job queue 604. Unstarted job queue 602 and completed job queue 604 may be dedicated to fractionalized task distributor 600 or shared between multiple fractionalized task distributors.

Input module(s) 606 may include one or more scripts or units of program code that are configured to receive data from an external system, break it apart into multiple smaller chunks, and generate jobs for each of these chunks. An example input module could be the general file input (GFI) discussed below. Output module(s) 608 may include one or more scripts or units of program code that are configured to obtain a request for a large amount of data, break the request into multiple requests for smaller chunks of the data, and generate jobs for each of these chunks. An example output module could be the general file input (GFO) discussed below.

Notably, there may be multiple interchangeable input and output modules that are configured to perform different tasks, and instances of each can be assigned to a fractionalized task distributor. In some embodiments, a single fractionalized task distributor may be configured just for input or output, and thus may be associated with an input module or an output module, but not both. This is represented in FIG. 6 by the arrows respectively connecting to input module(s) 606 and output module(s) 608 being dashed rather than solid.

Fractionalized task distributor 600 may employ various types of scheduling policies when determining which job to select for execution. A summary of these policies are provided below, although other policies may be possible.

First-come, first-served (FCFS): Jobs are served in the order they arrive, with the oldest job being served first.

Last-come, first-served (LCFS): This policy serves the most recent job first and continues in reverse chronological order.

Priority queueing: Jobs are assigned priorities, and higher-priority jobs are served before lower-priority jobs. In some cases, higher-priority jobs are always selected over lower-priority jobs when both are in unstarted job queue 602. In other cases, lower-priority jobs may be selected in the presence of higher-priority jobs, but at a lower volume (e.g., 1 lower-priority job is selected for every 5 higher-priority jobs selected).

Weighted fair queueing (WFQ): Jobs are assigned weights, and jobs are selected from unstarted job queue 602 based on these weights.

Shortest job next (SJN): Jobs are prioritized based on their expected execution times, with the shortest job being served first.

Longest job next (LJN): This discipline serves the request with the longest remaining execution time first. It is the opposite of SJN and can be used in scenarios where long-running jobs are to be prioritized.

Multilevel queueing: Jobs are divided into different priority levels, and each level has its own scheduling policy. Jobs in higher-priority queues are served first.

A fractionalized task distributor such as fractionalized task distributor 600 may be instantiated (e.g., created) on demand by a user or administrator. Alternatively, a fractionalized task distributor may be instantiated automatically and/or according to a schedule. Fractionalized task distributors may also be decommissioned (e.g., deleted) on demand or automatically when they are no longer needed or desired.

### B. Overall Framework

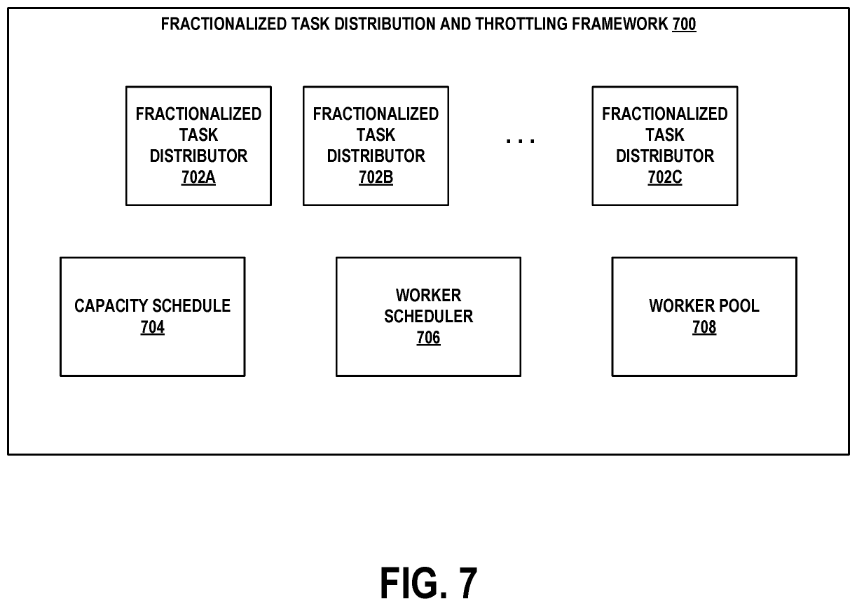

FIG. 7 depicts an overall fractionalized task distribution and throttling framework 700. It includes fractionalized task distributors 702A, 702B, and 702C. The ellipsis indicates that more or fewer than three fractionalized task distributors may be present. Each of these fractionalized task distributors are instantiations of fractionalized task distributor 600, and may have its own worker size. Framework 700 may be arranged to allocate workers to the fractionalized task distributors, taking these worker sizes into account.

Capacity schedule 704 may specify the total number of available workers at various points in time. For instance, capacity schedule 704 may be based on a daily 24-hour cycle and define the number of available workers in 15-minute, 30-minute, or 60-minute slots thereof. As an example, Table 1 provides one possible capacity schedule.

TABLE 1

| Hour of Day | Max Workers |
|---|---|
| 12AM-6AM | 160 |
| 6AM-11AM | 80 |
| 11AM-6PM | 40 |
| 6PM-12AM | 160 |

In Table 1, there are a maximum of 160 workers from 12 AM-6 AM. In other words, all fractionalized task distributors share these 160 workers. From 6 AM-11 AM, there are a maximum of 80 workers shared by the fractionalized task distributors. From 11 AM-6 PM, there are a maximum of 40 workers shared by the fractionalized task distributors. From 6 PM-12 AM, there are a maximum of 160 workers shared by the fractionalized task distributors. This capacity schedule reflects the diurnal cycle exhibited by many computing systems. There often is a need to reserve computing resources for high-interactivity (e.g., user facing) tasks during working hours, while bulk tasks can utilize more capacity in the overnight hours. In some embodiments, a percentage of overall workers or some other designation may be used to specify the portion of computing resources usable by the fractionalized task distributors.

Worker scheduler 706 may allocate available workers from worker pool 708 to fractionalized task distributors. Thus, when one or more workers are available in worker pool 708 and at least two fractionalized task distributors have been allocated fewer workers than their worker sizes, worker scheduler 706 may determine how to allocate the available workers to these fractionalized task distributors. In the case that just one fractionalized task distributor has been allocated fewer workers than its worker size, this fractionalized task distributor may be allocated some or all of the available workers.

Worker scheduler 706 may employ one or more scheduling techniques that take into account the priorities of the fractionalized task distributors (if these priorities exist). Weighed round robin is one possible scheduling technique. In it, the available workers are assigned to fractionalized task distributors in groups of one or more until all available workers are assigned or no more workers are needed. The weights are based on the fractionalized task distributor priorities with more available workers being assigned to fractionalized task distributors with higher priorities during each round robin cycle. Other scheduling techniques include weighted fair queueing, deficit round robin, and hierarchical token bucket. In some environments, FCFS may be used in the worker allocation process to preferentially assign workers to the fractionalized task distributors based on the order of when they were started. It is also possible for worker scheduler 706 to reserve a small amount of capacity (e.g., 1 to 2 workers) for each fractionalized task distributor so that jobs are not starved of resources.

Worker pool 708 is a repository for unallocated workers. At system initiation, all workers begin in worker pool 708. As workers are allocated to fractionalized task distributors, they are removed from worker pool 708. When workers are no longer needed or used by a fractionalized task distributor, they are placed back in worker pool 708.

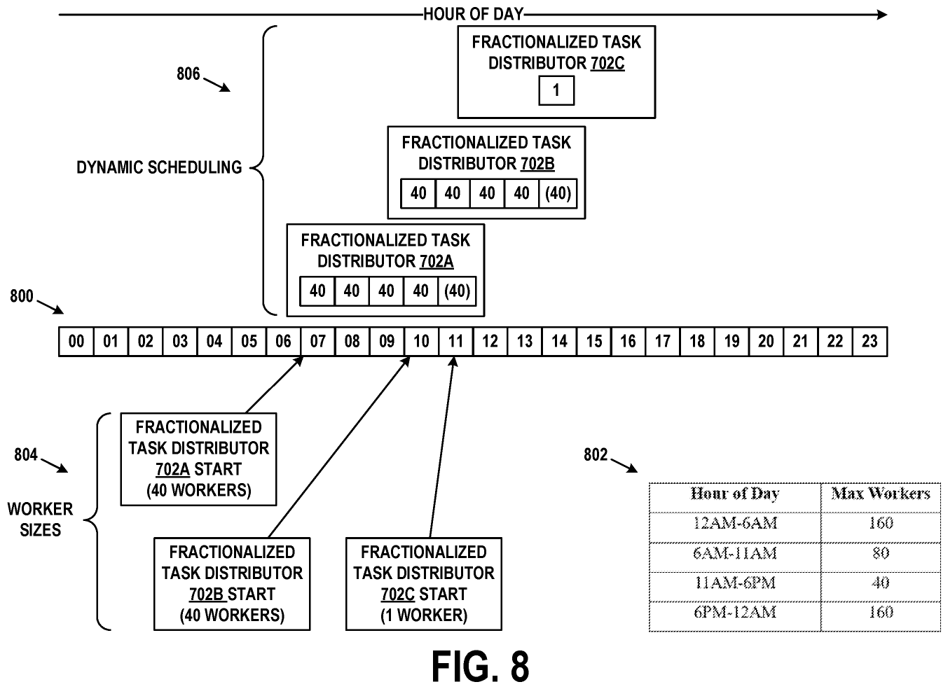

FIG. 8 depicts an example of worker assignments to fractionalized task distributors over a period of time. Time line 800 represents the hours of the day, with block 00 standing for 12 AM-1 AM, block 23 standing for 11 PM-12 AM, and blocks 01-22 standing for respective hours in between. Capacity schedule 802 specifies the number of total workers available during each hour of the day. Notably, capacity schedule 802 is the same as that of Table 1.

Worker sizes 804 defines the number of workers requested for each of fractionalized task distributor 702A (40), fractionalized task distributor 702B (40), and fractionalized task distributor 702C (1). This part of FIG. 8 also indicates when each fractionalized task distributor is intended to begin execution, fractionalized task distributor 702A at 7 AM, fractionalized task distributor 702B at 10 AM, and fractionalized task distributor 702C at 11 AM. These may be the times that the fractionalized task distributor were previously scheduled to execute or when they were dynamically executed.

Dynamic scheduling 806 depicts execution of the fractionalized task distributors, beginning at these times. Thus, at 7 AM, fractionalized task distributor 702A begins execution. Capacity schedule 802 specifies that there are a maximum of 80 workers available at this time (all are free because no other fractionalized task distributors are executing). Thus, fractionalized task distributor 702A is allocated its requested 40 workers, and executes using this number of workers until completion. Notably, the last block of time in which fractionalized task distributor 702A executes (11 AM-12 PM) shows the number of allocated workers in parentheses as “(40)”. This indicates that fewer than 40 workers may be used during this time once less than 40 jobs are left to execute (i.e., some of the allocated 40 workers become idle and may be returned to worker pool 708).

At 10 AM, fractionalized task distributor 702B begins execution. Capacity schedule 802 specifies that there is still a maximum of 80 workers available at this time, though 40 are being used by fractionalized task distributor 702A. Thus, fractionalized task distributor 702B is allocated its requested 40 workers, and executes using this number of workers until completion. As was the case for fractionalized task distributor 702A, the last block of time in which fractionalized task distributor 702B executes (2 PM-3 PM) shows the number of allocated workers in parentheses as “(40)”. This indicates that fewer than 40 workers may be used during this time once less than 40 jobs are left to execute (i.e., some of the allocated 40 workers become idle).

Fractionalized task distributors 702A and 702B each continue executing with 40 workers (80 workers total) even though this means that they exceed the 40 worker limit of capacity schedule 802 at 11 AM. This is because whether a fractionalized task distributor begins execution is based on the worker limit of capacity schedule 802 at the time that this execution begins. Here, fractionalized task distributor 702B begins execution at 10 AM because the worker limit of capacity schedule 802 is 80 at that time. Once a fractionalized task distributor begins execution with a given number of workers, it may be permitted to continue executing until completion with that number of workers (as noted above, the actual number of workers used will tail off at the end of the execution).

At 11 AM, fractionalized task distributor 702C is scheduled to begin execution. The total demand for workers across all fractionalized task distributor (81) exceeds the number (40) for the 11 AM-12 PM block in capacity schedule 802. Therefore, execution of fractionalized task distributor 702C is delayed until there is the requested 1 free worker within the total supply of workers. Thus, the actual start time of fractionalized task distributor 702C is in the 2 PM-3 PM block, as that is when some of the 40 workers assigned to fractionalized task distributor 702B become idle.

Notably, this is just one possible scheduling discipline that could be used. Other examples are possible, potentially giving preferences to fractionalized task distributors based on their priorities, allowing some fractionalized task distributors to interrupt the progress of others (e.g., by taking their workers), and so on.

At 12 PM, fractionalized task distributor 702A has completed all of its jobs and has returned its workers to worker pool 708. Likewise, at 3 PM, fractionalized task distributors 702B and 702C have completed all of their jobs and has returned their workers to worker pool 708.

The example of FIG. 8 is intended to be illustrative and non-limiting. Other numbers of fractionalized task distributors with different worker sizes can be allocated workers in accordance with different dynamic scheduling disciplines and different capacity schedules. For example, some jobs may have a parent/child relationship, where the parent job must complete before the child job begins. In these cases, the fractionalized task distribution and throttling framework may refrain from scheduling or beginning execution of the child job until the parent job completes.

Additionally, despite the general context of fractionalized task distribution and throttling herein being focused on transfers of large data objects, other parallelizable jobs may benefit from the framework. These include, but are not limited to, training of machine learning models, performing remote API calls, carrying out security scans (e.g., virus scans) on a filesystem, and so on.

### C. Generalized File Input (GFI)

GFI is a specific example of input module 606 that receives a file from an external system and breaks apart this file into multiple smaller files. Each smaller file becomes a job that a fractionalized task distributor can process in accordance with the framework. For example, the large file may be broken apart by accessing the stream content of the file and iterating over each line using a text reader. This results in extremely fast processing and efficient use of memory. For example, tens of millions of lines can be processed in only a few minutes or less to create smaller files.

The large file may be a flat text file, a structured text file, or some other type of file (e.g., including non-text binary characters). Structured text file types include XML, Javascript Object Notation (JSON), comma-separated value (CSV), and other types of files. In some cases, the large file may contain a representation of a database table that is being read into a computational instance of remote network management platform 320 (e.g., as part of a restore backup operation or as another form of transfer from an external system).

The fractionalized task distributor can start processing multiple jobs concurrently up to its maximum worker size or number of allocated workers, whichever is smaller. This processing can begin while the large file is still being broken apart. This parallel processing of breaking up the file, assigning jobs to workers, and the workers processing the jobs makes the overall procedure fast and efficient.

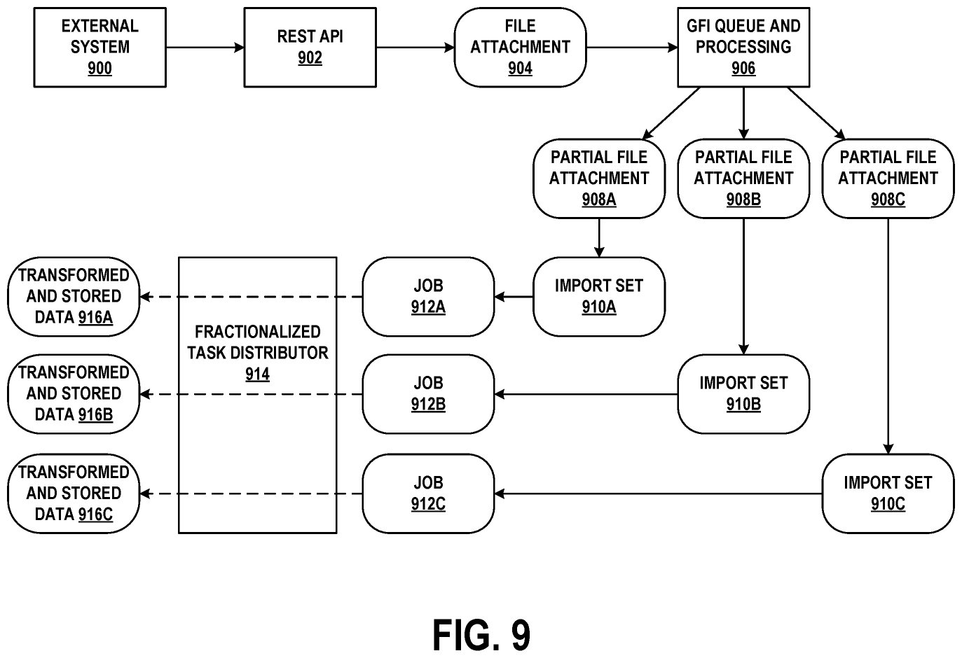

FIG. 9 depicts GFI in the context of fractionalized task distributor. In FIG. 9, boxes with square corners generally refer to hardware and software components or processing steps, while boxes with rounded corners refer to data.

File attachment 904 may be received from external system 900 by way of representational state transfer (REST) API 902. File attachment 904 may be a text or non-text binary file that was requested from external system 900 by way of a REST API call, for example. This file may be large (e.g., up to or exceeding multiple gigabits in size). File attachment 904 is routed to GFI queue and processing 906.

GFI queue and processing 906 breaks file attachment 904 into partial file attachments 908A, 908B, and 908C. In FIG. 9, just three partial file attachments are shown for sake of simplicity. In various situations, more or fewer partial file attachments may be used. In some cases, there may be hundreds or thousands of partial file attachments.

GFI queue and processing 906 may break up file attachment 904 based on the content of file attachment 904. Therefore, this process may be customized for files that hold different types of content. For example, a CSV file may be broken up into one partial file attachment for every n rows, while a JSON or XML file may be broken up into one partial file for every n instances of a specific tagged object (e.g., a unit of data with a specific JSON key/value pair or with a specific XML tag or set of tags). Other types of files may be broken up so that each partial file attachment is no more than a threshold number of bytes.

Each partial file attachment may be stored temporarily as an import set. Import sets are data being staging for further processing. Thus, partial file attachment 908A, 908B, and 908C may be stored as import sets 910A, 910B, and 910C, respectively.

Each of these import sets may be viewed as a job by a fractionalized task distributor. Thus fractionalized task distributor 914 may arrange import sets 910A, 910B, and 910C as jobs 912A, 912B, and 912C. Fractionalized task distributor 914 may also schedule and execute jobs 912A, 912B, and 912C in any of the manners described above, for example.

During and/or after execution, each job may be transformed and stored according to various rules. For instance, a job for a partial file attachment may involve transforming a row of a CSV file or a tagged object of a JSON or XML file into an entry in a database table, with fields of the entry corresponding to the content of the row or tagged object. Thus, the result of executing jobs 912A, 912B, and 912C may be transformed and stored data 916A, 916B, and 916C, respectively.

### D. Generalized File Output (GFO)

GFO breaks apart a large-result single query into multiple smaller queries. Each smaller query becomes a job for a fractionalized task distributor to process. GFO writes a file from each query that can be downloaded by an external system. One distinct advantage to this technique it does not have to return a full result from the query. Instead, it performs an aggregate count of the total rows that would be returned by the query and then divides the total by a batch size. Each batch represents a much smaller query and result.

As an example, a database query that would return 10 million entries would typically take 3-4 hours to serially iterate through the database. Such a query may be broken into 200 queries for 50,000 entries each. Each of these smaller queries will only take on approximate 1 minute on average to provide its result. Thus, a fractionalized task distributor can start processing multiple these smaller queries simultaneously up to a maximum concurrent number of workers for the fractionalized task distributor that are available. Thus, with 50 workers, all queries can be completed in about 4 minutes. This makes the overall process extremely fast and efficient, while still allowing platform computing resources to be shared with other tasks, applications, and programs.

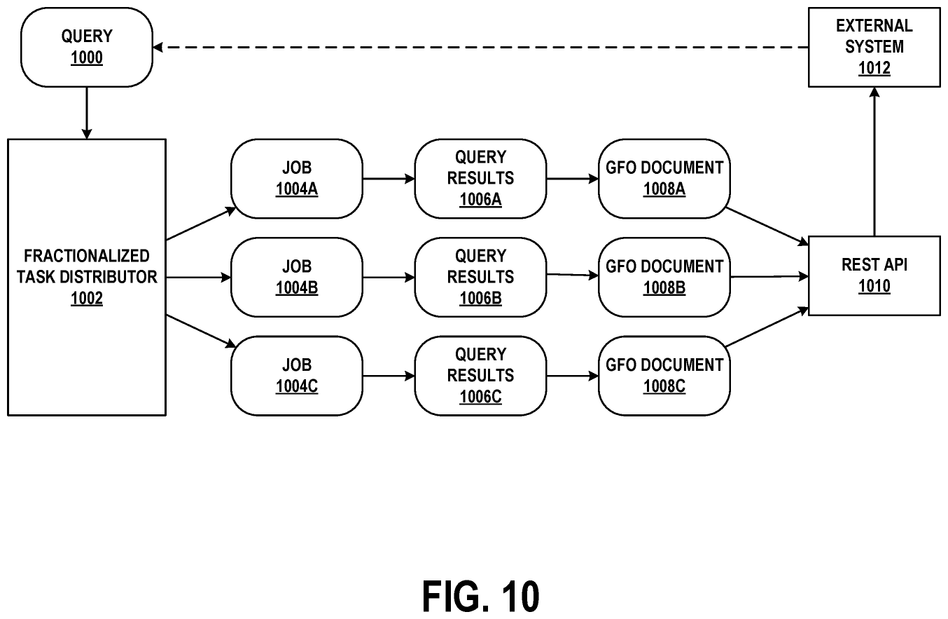

FIG. 10 depicts GFO in the context of fractionalized task distribution. As was the case for FIG. 9, boxes with square corners generally refer to hardware and software components or processing steps, while boxes with rounded corners refer to data.

Query 1000 is received by a platform that supports the fractionalized task distribution mechanisms that are described herein. Query 1000 might return a large data object as a result (e.g., a several-gigabit file or a millions of rows of a database table), though GFO is advantageous even when the result returned is smaller. As indicated by the dotted line, query 1000 may originate from external system 1012. For instance, query 1000 may be a request made by way of a REST API on the platform.

Fractionalized task distributor 1002 may receive a representation of the request and determine how to break up the requested data object. This may initially involve determining the actual or approximate size of the data object. For example, if the data object is a file, the size of the file can be determined by an API call to the platform's file system. If the data object includes entries in a database table, the total number of entries in the result can be counted to determine the actual or approximate size of the result.

After the size of the result is determined, fractionalized task distributor 1002 may further determine how many chunks in which to break up the data object. In line with the example above, a database query that would return 10 million entries may be broken into 200 queries for 50,000 entries each. In the example shown in FIG. 10, query 1000 is broken into three smaller queries, and each of these smaller queries is executed as a separate job by fractionalized task distributor 1002. Thus, jobs 1004A, 1004B, and 1004C may be executed by fractionalized task distributor 1002 in parallel or at least partially in parallel.

Jobs 1004A, 1004B, and 1004C may produce query results 1006A, 1006B, and 1006C, respectively. Each of these query results may be a partial file or a non-overlapping set of entries from a database table for example. GFO documents 1008A, 1008B, and 1008C may be formulated from query results 1006A, 1006B, and 1006C, respectively. Each of GFO documents 1008A, 1008B, and 1008C may be a query result in the form of a file (e.g., a partial file or a file formed from the concatenation of database entries. In the latter case, the database entries may be transformed into JSON or XML data objects, for example.

GFO documents 1008A, 1008B, and 1008C may be placed in temporary storage such that they can be requested individually by external system 1012. For example, each of GFO documents 1008A, 1008B, and 1008C may be associated with a unique URL. Thus, if external system 1012 provided query 1000, then the response to this query may be a list of URLs from which GFO documents 1008A, 1008B, and 1008C can be retrieved.

More or fewer queries, jobs, query results, and GFO documents may be used. As noted, query 1000 can be broken up in various ways based on the type of data object being requested, its size, fractionalized task distributor configuration, capacity of the platform, and other factors.

### VII. Example Technical Improvements

These embodiments provide a technical solution to a technical problem. One technical problem being solved is efficient fractionalized task distribution for transfer of large data objects (e.g., files or sets of database entries) into and out of a computing platform. In practice, this is problematic because such transfers can take hours or more if performed serially, and there are no mechanisms on multiprocessing systems to prevent the computing platform from being overwhelmed with many such transfers or other tasks.

In the prior art, there was no system-level control of data object transfers. This would lead to slowness, unreliability, and instability of the computing platform in situations where it has insufficient computing resources. Thus, prior art techniques did little if anything to address the problems described above.

The embodiments herein overcome these limitations by providing for a framework in which multiple fractionalized task distributors can intelligently share available computing resources. In this manner, fractionalized task distribution can be accomplished in a more robust fashion. This results in several advantages. First, individual transfers of data objects into and out of the computing platform can be sped up through parallelization when computing resources support doing so. Second, multiple fractionalized task distributors share a predefined amount of these computing resources so that the computing platform remains responsive even when under heavy load. Third, the amount of computing resources reserved for sharing amongst fractionalized task distributors can vary over time, allowing the computing platform to adapt in the presence of diurnal load patterns or other scheduled tasks.

Other technical improvements may also flow from these embodiments, and other technical problems may be solved. Thus, this statement of technical improvements is not limiting and instead constitutes examples of advantages that can be realized from the embodiments.

### VIII. Example Operations

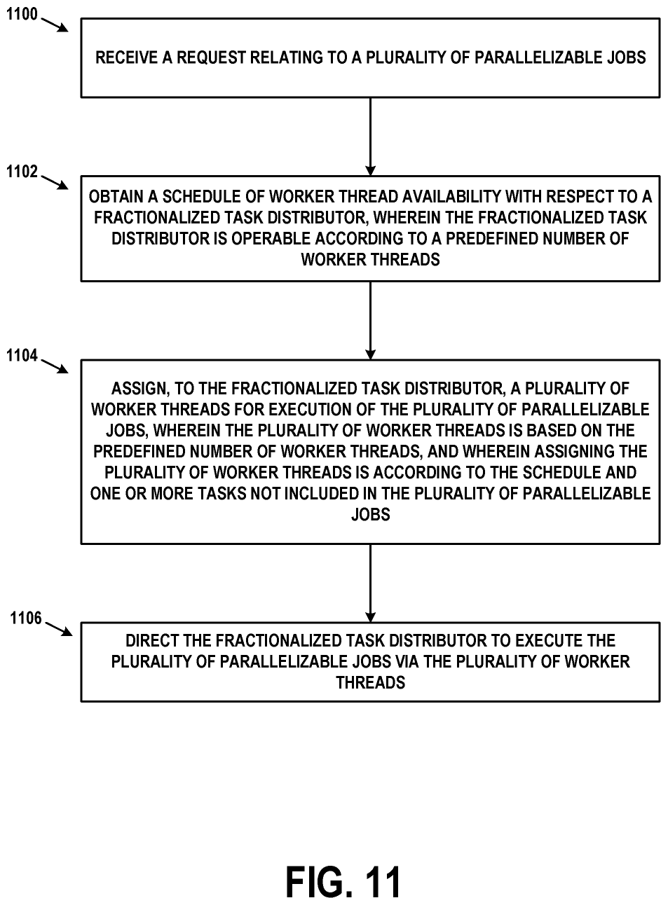

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1100 may involve receiving a request relating to a plurality of parallelizable jobs.

Block 1102 may involve obtaining a schedule of worker thread availability with respect to a fractionalized task distributor, wherein the fractionalized task distributor is operable according to a predefined number of worker threads.

Block 1104 may involve assigning, to the fractionalized task distributor, a plurality of worker threads for execution of the plurality of parallelizable jobs, wherein the plurality of worker threads is based on the predefined number of worker threads, and wherein assigning the plurality of worker threads is according to the schedule and one or more tasks not included in the plurality of parallelizable jobs.

Block 1106 may involve directing the fractionalized task distributor to execute the plurality of parallelizable jobs via the plurality of worker threads.

Some implementations may further involve: receiving a second request relating to a second plurality of parallelizable jobs, wherein the schedule of worker thread availability is also with respect to a second fractionalized task distributor, and wherein the second fractionalized task distributor is operable according to a second predefined number of worker threads; assigning, to the second fractionalized task distributor, a second plurality of worker threads for execution of the second plurality of parallelizable jobs, wherein the second plurality of worker threads is based on the second predefined number of worker threads, and wherein assigning the second plurality of worker threads is according to the schedule, the plurality of parallelizable jobs, and the one or more tasks not included in the plurality of parallelizable jobs or the second plurality of parallelizable jobs; and directing the second fractionalized task distributor to execute the second plurality of parallelizable jobs via the second plurality of worker threads at least partially concurrently with the fractionalized task distributor executing the plurality of parallelizable jobs via the plurality of worker threads.

In some implementations, a sum of the predefined number of worker threads and the second predefined number of worker threads is greater than a count of worker threads from the schedule of worker thread availability, wherein a sum of the plurality of worker threads assigned to the fractionalized task distributor and the second plurality of worker threads assigned to the second fractionalized task distributor is less than or equal to the count of worker threads.

In some implementations, the plurality of worker threads assigned to the fractionalized task distributor and the second plurality of worker threads assigned to the second fractionalized task distributor are both at least 1.

In some implementations, the plurality of worker threads assigned to the fractionalized task distributor and the second plurality of worker threads assigned to the fractionalized task distributor are based on respective priorities of the fractionalized task distributor and the second fractionalized task distributor.

In some implementations, the predefined number of worker threads corresponds to a maximum number of worker threads that can be assigned to the fractionalized task distributor.

In some implementations, the plurality of worker threads is less than or equal to the predefined number of worker threads.

In some implementations, directing the fractionalized task distributor to execute the plurality of parallelizable jobs comprises directing the fractionalized task distributor to execute the plurality of parallelizable jobs at least partially in parallel with one another.

In some implementations, the plurality of parallelizable jobs relate to reception of a data object into a computing platform that executes the fractionalized task distributor, wherein the parallelizable jobs respectively relate to reception of non-overlapping portions of the data object.

In some implementations, reception of the data object into the computing platform comprises writing representations of the non-overlapping portions of the data object into entries of one or more database tables of the computing platform.

In some implementations, reception of the data object into the computing platform comprises breaking the data object into the non-overlapping portions of the data object, wherein the plurality of parallelizable jobs are respectively associated with processing of the non-overlapping portions of the data object, and wherein executing the plurality of parallelizable jobs via the plurality of worker threads comprises transforming the non-overlapping portions of the data object into a storage format supported by the computing platform.

In some implementations, the plurality of parallelizable jobs relate to responding, by a computing platform that executes the fractionalized task distributor, to a query for a data object, wherein the parallelizable jobs respectively relate to non-overlapping portions of the data object.

In some implementations, responding to the query for the data object comprises reading representations of the non-overlapping portions of the data object from entries of one or more database tables of the computing platform.

In some implementations, responding to the query for the data object comprises breaking the query into a set of queries for the non-overlapping portions of the data object, wherein the plurality of parallelizable jobs are respectively associated with processing of the queries, and wherein executing the plurality of parallelizable jobs via the plurality of worker threads comprises obtaining the non-overlapping portions of the data object and providing them in response to the query.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving a request relating to a plurality of parallelizable jobs;
obtaining a schedule of worker thread availability with respect to a fractionalized task distributor, wherein the fractionalized task distributor is operable according to a predefined number of worker threads;
assigning, to the fractionalized task distributor, a plurality of worker threads for execution of the plurality of parallelizable jobs, wherein the plurality of worker threads is based on the predefined number of worker threads, and wherein assigning the plurality of worker threads is according to the schedule and one or more tasks not included in the plurality of parallelizable jobs; and
directing the fractionalized task distributor to execute the plurality of parallelizable jobs via the plurality of worker threads.

2. The method of claim 1, further comprising:
receiving a second request relating to a second plurality of parallelizable jobs, wherein the schedule of worker thread availability is also with respect to a second fractionalized task distributor, and wherein the second fractionalized task distributor is operable according to a second predefined number of worker threads;
assigning, to the second fractionalized task distributor, a second plurality of worker threads for execution of the second plurality of parallelizable jobs, wherein the second plurality of worker threads is based on the second predefined number of worker threads, and wherein assigning the second plurality of worker threads is according to the schedule, the plurality of parallelizable jobs, and the one or more tasks not included in the plurality of parallelizable jobs or the second plurality of parallelizable jobs; and
directing the second fractionalized task distributor to execute the second plurality of parallelizable jobs via the second plurality of worker threads at least partially concurrently with the fractionalized task distributor executing the plurality of parallelizable jobs via the plurality of worker threads.

3. The method of claim 2, wherein a sum of the predefined number of worker threads and the second predefined number of worker threads is greater than a count of worker threads from the schedule of worker thread availability, and wherein a sum of the plurality of worker threads assigned to the fractionalized task distributor and the second plurality of worker threads assigned to the second fractionalized task distributor is less than or equal to the count of worker threads.

4. The method of claim 2, wherein the plurality of worker threads assigned to the fractionalized task distributor and the second plurality of worker threads assigned to the second fractionalized task distributor are both at least 1.

5. The method of claim 2, wherein the plurality of worker threads assigned to the fractionalized task distributor and the second plurality of worker threads assigned to the second fractionalized task distributor are based on respective priorities of the fractionalized task distributor and the second fractionalized task distributor.

6. The method of claim 1, wherein the predefined number of worker threads corresponds to a maximum number of worker threads that can be assigned to the fractionalized task distributor.

7. The method of claim 1, wherein the plurality of worker threads is less than or equal to the predefined number of worker threads.

8. The method of claim 1, wherein directing the fractionalized task distributor to execute the plurality of parallelizable jobs comprises directing the fractionalized task distributor to execute the plurality of parallelizable jobs at least partially in parallel with one another.

9. The method of claim 1, wherein the plurality of parallelizable jobs relate to reception of a data object into a computing platform that executes the fractionalized task distributor, and wherein the parallelizable jobs respectively relate to reception of non-overlapping portions of the data object.

10. The method of claim 9, wherein reception of the data object into the computing platform comprises writing representations of the non-overlapping portions of the data object into entries of one or more database tables of the computing platform.

11. The method of claim 9, wherein reception of the data object into the computing platform comprises breaking the data object into the non-overlapping portions of the data object, wherein the plurality of parallelizable jobs are respectively associated with processing of the non-overlapping portions of the data object, and wherein executing the plurality of parallelizable jobs via the plurality of worker threads comprises transforming the non-overlapping portions of the data object into a storage format supported by the computing platform.

12. The method of claim 1, wherein the plurality of parallelizable jobs relate to responding, by a computing platform that executes the fractionalized task distributor, to a query for a data object, and wherein the parallelizable jobs respectively relate to non-overlapping portions of the data object.

13. The method of claim 12, wherein responding to the query for the data object comprises reading representations of the non-overlapping portions of the data object from entries of one or more database tables of the computing platform.

14. The method of claim 12, wherein responding to the query for the data object comprises breaking the query into a set of queries for the non-overlapping portions of the data object, wherein the plurality of parallelizable jobs are respectively associated with processing of the queries, and wherein executing the plurality of parallelizable jobs via the plurality of worker threads comprises obtaining the non-overlapping portions of the data object and providing them in response to the query.

15. A non-transitory computer-readable medium, having stored thereon program instructions that, upon execution by a computing system, cause the computing system to perform operations comprising:
receiving a request relating to a plurality of parallelizable jobs;
obtaining a schedule of worker thread availability with respect to a fractionalized task distributor, wherein the fractionalized task distributor is operable according to a predefined number of worker threads;
assigning, to the fractionalized task distributor, a plurality of worker threads for execution of the plurality of parallelizable jobs, wherein the plurality of worker threads is based on the predefined number of worker threads, and wherein assigning the plurality of worker threads is according to the schedule and one or more tasks not included in the plurality of parallelizable jobs; and
directing the fractionalized task distributor to execute the plurality of parallelizable jobs via the plurality of worker threads.

16. The non-transitory computer-readable medium of claim 15, the operations further comprising:
receiving a second request relating to a second plurality of parallelizable jobs, wherein the schedule of worker thread availability is also with respect to a second fractionalized task distributor, and wherein the second fractionalized task distributor is operable according to a second predefined number of worker threads;
assigning, to the second fractionalized task distributor, a second plurality of worker threads for execution of the second plurality of parallelizable jobs, wherein the second plurality of worker threads is based on the second predefined number of worker threads, and wherein assigning the second plurality of worker threads is according to the schedule, the plurality of parallelizable jobs, and the one or more tasks not included in the plurality of parallelizable jobs or the second plurality of parallelizable jobs; and
directing the second fractionalized task distributor to execute the second plurality of parallelizable jobs via the second plurality of worker threads at least partially concurrently with the fractionalized task distributor executing the plurality of parallelizable jobs via the plurality of worker threads.

17. The non-transitory computer-readable medium of claim 16, wherein the plurality of worker threads assigned to the fractionalized task distributor and the second plurality of worker threads assigned to the second fractionalized task distributor are based on respective priorities of the fractionalized task distributor and the second fractionalized task distributor.

18. The non-transitory computer-readable medium of claim 15, wherein the plurality of parallelizable jobs relate to reception of a data object into a computing platform that executes the fractionalized task distributor, and wherein the parallelizable jobs respectively relate to reception of non-overlapping portions of the data object.

19. The non-transitory computer-readable medium of claim 15, wherein the plurality of parallelizable jobs relate to responding, by a computing platform that executes the fractionalized task distributor, to a query for a data object, and wherein the parallelizable jobs respectively relate to non-overlapping portions of the data object.

20. A system comprising:
one or more processors; and
memory, containing program instructions that, upon execution by the one or more processors, cause the system to perform operations comprising:
receiving a request relating to a plurality of parallelizable jobs;
obtaining a schedule of worker thread availability with respect to a fractionalized task distributor, wherein the fractionalized task distributor is operable according to a predefined number of worker threads;
assigning, to the fractionalized task distributor, a plurality of worker threads for execution of the plurality of parallelizable jobs, wherein the plurality of worker threads is based on the predefined number of worker threads, and wherein assigning the plurality of worker threads is according to the schedule and one or more tasks not included in the plurality of parallelizable jobs; and
directing the fractionalized task distributor to execute the plurality of parallelizable jobs via the plurality of worker threads.
